(19) United States
(12) Patent Application Publication
(10) Pub. No.: US 2026/0276544 A1
(43) Pub. Date: Sep. 17, 2026

(54) Method for Analyzing Aggregation-Crystallization Process of Calcium Phosphate Prenucleation Cluster

(71) Applicant: Wuhan University of Technology, Hubei (CN)

(72) Inventors: Yingchao Han, Hubei (CN); Jia Chen, Hubei (CN)

(21) Appl. No.: 19/283,782

(22) Filed: Jul. 29, 2025

(30) Foreign Application Priority Data
Mar. 12, 2025 (CN) 202510290844.2

(51) Int. Cl. G01N 21/64; G01N 1/30

(52) U.S. Cl. CPC G01N 21/643; G01N 1/30; G01N 2021/6439

(57) ABSTRACT

A method for analyzing an aggregation-crystallization process of a calcium phosphate prenucleation cluster. A small amount of the aggregation-induced emission organic molecule and the rare earth ion are doped into the calcium phosphate prenucleation cluster, and the two are used as a fluorescent dual probe to participate in the subsequent evolution process. The organic molecule binds to the calcium ion in the cluster. As the local molecular density of the aggregated organic molecules of the PNCs increases, the limitation of intramolecular motion is further strengthened, the energy loss of the excited state is reduced, resulting in opening of the electron transition channel and showing a phenomenon of enhanced fluorescence signal.

### CROSS-REFERENCE TO RELATED APPLICATION

This application claims priority to Chinese Patent Application No. 202510290844.2, filed Mar. 12, 2025, the disclosure of which is hereby incorporated by reference in its entirety.

### BACKGROUND

The present disclosure belongs to the technical field of material analysis, and particularly relates to a method for analyzing an aggregation-crystallization process of a calcium phosphate prenucleation cluster.

A main inorganic phase in a hard tissue (such as a bone, a tooth) of an organism is calcium phosphate, which is formed by biomineralization under the regulation of a biological molecule in vivo. Exploring main factors regulating calcium phosphate mineralization and revealing a related mineralization mechanism have a guiding significance for the treatment of clinical pathological mineralization diseases and deepening the understanding of biomineralization. Studies have shown that the biomineralization pertains to a non-classical crystallization process. That is, calcium phosphate clusters are formed in a solution, the clusters aggregate into an amorphous phase, and finally the amorphous phase is subjected to phase change to form a crystalline phase. It is currently known that the calcium phosphate in vivo has different physical phases, e.g. amorphous calcium phosphate and hydroxyapatite, but the molecular regulation mechanism of its aggregation and crystallization still needs further study.

Non-in-situ methods cannot achieve continuous in-situ signal acquisition because samples need to be separated, and the information that can be acquired is limited. In-situ characterization methods such as high energy X-ray diffraction (HE-XRD) can probe the crystal phase transformation of perovskite nanocrystals (PNCs), but they have high requirements on sample crystallinity. Atomic force microscopy (AFM) and Raman spectroscopy can reveal the dynamic changes in the morphology and composition of the PNCs, but the probing information is limited. In-situ liquid phase transmission electron microscopy (In situ-TEM) can simultaneously study the morphology and phase transformation process of the PNCs, but the testing cost is high. Therefore, there is an urgent need to develop accurate and reliable characterization techniques suitable for the calcium phosphate biomineralization process.

### SUMMARY

Provided in the present disclosure is a method for analyzing an aggregation-crystallization process of a calcium phosphate prenucleation cluster which overcomes the above problems in the existing technology.

An aggregation-induced emission (AIE) organic molecule can effectively limit intramolecular motion and exhibit unique fluorescence properties that do not emit at a low concentration but emit strongly in a condensed state. Its applications in solid-state lighting, specific detection, near-infrared imaging and the like fields have attracted widespread attention. It has been found by studies that the utilization of a tetraphenylethylene fluorescent probe can achieve visualization of the macroscopic dispersion and spatial distribution of a montmorillonite in a polyvinyl chloride matrix. A rare earth ion has a narrow emission band, a definite magnetic dipole and electric dipole transition, and can also be used as a spectroscopic probe for material structural resolution. Studies have shown that an Eu³⁺ probe can be used for identifying the physical phase transitions of monoclinic, tetragonal and cubic crystals of zirconium oxide. The present disclosure utilizes the aggregation-induced emission characteristic of the organic molecule to respond to the “cluster aggregation process” and utilizes the ultrasensitive transition characteristic of the rare earth ion to respond to the “coordination environment asymmetry”, so as to construct a fluorescent dual probe to respectively probe the aggregation-crystallization process of the calcium phosphate prenucleation cluster, and fluorescently signalize the aggregation-crystallization process of the PNCs, providing a novel in-situ characterization method for studying calcium phosphate biomineralization.

The present disclosure provides a method for analyzing an aggregation-crystallization process of a calcium phosphate prenucleation cluster, including:
mixing a polyanion, an aggregation-induced emission organic molecule, a calcium ion and a rare earth ion in water to obtain a prenucleation cluster precursor solution;
mixing the prenucleation cluster precursor solution with a phosphate ion to obtain a prenucleation cluster solution;
inducing aggregation and crystallization of the prenucleation cluster solution sequentially to obtain an aggregated and crystallized product;
subjecting the aggregated and crystallized product to fluorescence detection; and
analyzing a formation process of the calcium phosphate prenucleation cluster by using a fluorescence signal.

Preferably, the polyanion is selected from at least one of polyacrylic acid, polyaspartic acid, polyglutamic acid, and polyacrylamine hydrochloride.

The biomineralization is a non-classical crystallization process. That is, prenucleation clusters are first formed, then aggregate into an amorphous phase, and then the amorphous phase undergoes a phase transition to form a crystalline structure. Charged substances are often involved in this process. For example, proteins are often involved in the regulation of the mineralization processes of human bones and teeth, and organic materials are involved in the formation process of shell cases. In the present disclosure, the polyanion is added as a process guidance agent, which can guide the formation of a polymer-induced precursor (PILP) and simulate a non-classical crystallization path of actual biomineralization; and the entire mineralization process can be regulated by setting the parameters of the polymer guidance agent, providing convenience for studying the specific mechanism of mineralization.

Preferably, the aggregation-induced emission organic molecule includes at least one of tetrakis(4-carboxyphenyl)ethylene, 9,10-di(4-carboxyphenyl) anthracene, 1,2,4,5-tetrakis(4-carboxyphenyl)benzene, and 2,3,5,6-tetrakis(4-carboxyphenyl) pyrazine.

Preferably, the rare earth ion includes at least one of a europium ion, a terbium ion, a cerium ion, a dysprosium ion, a thulium ion, and a samarium ion.

Preferably, a molar ratio of the calcium ion to the rare earth ion is 1: (0.005 to 0.05).

Preferably, a molar ratio of the calcium ion to the polyanion is 1:(1 to 3).

Preferably, a molar ratio of the calcium ion to the aggregation-induced emission organic molecule is 1:(0.005 to 0.05).

Preferably, a molar ratio of the calcium ion to the phosphate ion is 1:(0.1 to 1).

Preferably, the method further includes: mixing a polyanion aqueous solution, an aggregation-induced emission organic molecule aqueous solution, a calcium ion aqueous solution and a rare earth ion aqueous solution, and stirring at 25° C. to 80° C. for 2 h to 12 h to obtain a prenucleation cluster precursor solution.

Preferably, a pH value of the prenucleation cluster precursor solution is 6 to 12; and a pH value of the prenucleation cluster solution is 6 to 12.

More preferably, NaOH is adopted to adjust the pH value.

Preferably, the method of inducing aggregation of the prenucleation cluster solution includes adding a calcium ion into the prenucleation cluster solution to obtain a mixed solution, or evaporating water in the mixed solution.

More preferably, a manner of the evaporation includes stirring the mixed solution at 25° C. to 50° C. for 1 h to 3 h.

Further preferably, the mixed solution is stirred at 35° C. to 40° C. for 1.5 h to 2.5 h.

More preferably, a molar ratio of the amount of the calcium ion added into the prenucleation cluster solution to the amount of the calcium ion in the prenucleation cluster solution is (0.5 to 3):1.

Preferably, a manner of the crystallization includes adding a phosphate into the mixed solution after the aggregation.

Preferably, the method includes: fitting a Boltzmann model according to the fluorescence signal to analyze the aggregation behavior of the calcium phosphate prenucleation cluster.

More preferably, the fluorescence signal includes fluorescence emission characteristic peaks of the organic molecule and the rare earth ion. For the fluorescence characteristic peak of the organic molecule, the emission light intensity amplification rate is calculated as: ΔI=(I−Iₚᵣₑ)/Iₚᵣₑ where I and Ipre represent the fluorescence characteristic peak intensities of the PNCs solution and the PNCs aggregation crystallization product, respectively, the Boltzmann model is adopted to fit a change curve of ΔI:

$$Δ I = ( {A}_{1} - {A}_{2} ) / ( 1 + exp [ \frac{c - {c}_{0}}{Δ c} ] ) + {A}_{2} ,$$

where A₁ and A₂ are respectively ΔI at high and low concentrations of the calcium ion, and co is a midpoint of curve mutation, which can be used as a critical micelle concentration (CMC) of the colloid; and for the fluorescence characteristic peak of the rare earth ion, a ratio R_{I} of the fluorescence characteristic peak intensities corresponding to the electric dipole transition (supersensitive transition) and the magnetic dipole transition is calculated.

More preferably, the method further includes determining a size of a calcium phosphate agglomerate according to an amplification rate of the fluorescence signal of the organic molecule and a characteristic peak ratio of the rare earth ion.

More preferably, the method further includes determining a calcium phosphate crystal form according to the characteristic peak ratio of the rare earth ion.

More preferably, the method further includes monitoring crystal phase transformation of octacalcium phosphate (OCP) to hydroxyapatite (HAP) according to the characteristic peak ratio of the rare earth ion.

The beneficial effects of the present disclosure are as follows.

The present disclosure provides a method for analyzing an aggregation-crystallization process of a calcium phosphate prenucleation cluster. A small amount of the aggregation-induced emission organic molecule and the rare earth ion are doped into the calcium phosphate prenucleation cluster, and the two are used as a fluorescent dual probe to participate in the subsequent evolution process. The deprotonated organic molecule binds to the calcium ion in the cluster. As the local molecular density of the aggregated organic molecules of the PNCs increases, the limitation of intramolecular motion is further strengthened, the energy loss of the excited state is reduced, resulting in opening of the electron transition channel and showing a phenomenon of enhanced fluorescence signal. The electric dipole transition (supersensitive transition) of the rare earth ion is sensitive to the asymmetry of the surrounding coordination environment, while the magnetic dipole transition is insensitive. Therefore, the ratio of the two can be utilized to preliminarily determine the chemical structure of the rare earth ion. In summary, the present disclosure utilizes the aggregation-induced emission characteristic of the organic molecule to respond to the “cluster aggregation process” and utilizes the ultrasensitive transition characteristic of the rare earth ion to respond to the “coordination environment asymmetry” to match the aggregation-crystallization process of the PNCs and explain its biomineralization mechanism. Compared with the existing technology, the present disclosure can realize continuous dynamic monitoring of the aggregation crystallization behavior of the PNCs, and has the advantages of low cost and rich characteristics of detection materials.

### BRIEF DESCRIPTION OF THE DRAWINGS

FIG. 1A through FIG. 1G show the aggregation crystallization of CaP PNCs under different Ca²⁺ addition amounts as detected by the in-situ fluorescence probe method;

FIG. 2A through FIG. 2D show the aggregation crystallization of CaP PNCs at different temperatures as detected by the in-situ fluorescence probe method;

FIG. 3A through FIG. 3F show the aggregation crystallization of CaP PNCs under different pHs as detected by the in-situ fluorescence probe method;

FIG. 4 is a diagram showing a relationship between I₆₁₃/I₅₉₁ values of HAP and OCP blends with different content ratios;

FIG. 5 shows luminescent fluorescence spectra of a TPE-COOH solution at different Ca²⁺ addition amounts; and

FIG. 6A and FIG. 6B show the in-situ probing in a calcium phosphate crystallization process by a dual fluorescent probe, where FIG. 6A is an XRD pattern of a product after adding different concentrations of phosphates to trigger crystallization, and FIG. 6B is a diagram showing the relationship between different phosphate concentrations and the I₆₁₃/I₅₉₁ values of the product.

### DETAILED DESCRIPTION

The disclosed embodiments will be further explained in detail hereafter by specific examples. Unless otherwise specified, all the raw materials used in the following examples can be obtained from conventional commercial routes, or prepared through simple synthesis and isolated; and unless otherwise specified, the employed processes are all conventional processes in the art.

### Example 1

Example 1 provides a method for analyzing the aggregation-crystallization process of the calcium phosphate prenucleation cluster, which was specifically as follows.

1 g/L of a TPE-COOH (tetraphenylethylene-COOH) aqueous solution was formulated, and adjusted to a pH value of 9 to 10 by using NaOH. 5 mL of the TPE-COOH aqueous solution, 2 mmol and 25 mL of a PAA (polyacrylic acid) aqueous solution, 1 mmol and 5 mL of a calcium ion aqueous solution, and 0.03 mmol and 5 mL of a europium ion aqueous solution were stirred into 40 mL of a mixed solution, added with an appropriate amount of a NaOH aqueous solution to adjust the pH value of the mixed solution to 9, and stirred at 37° C. for 30 min to obtain a calcium phosphate prenucleation cluster precursor solution. The precursor solution was added with 0.6 mmol of a phosphate aqueous solution to set a final volume to 50 mL, and stirred continually at 37° C. for 2 h to obtain a calcium phosphate prenucleation cluster solution. The prenucleation cluster solution was added with 0, 0.2, 0.4, 0.6, 0.8, 1.0, 1.2, 1.5, 2.0, 2.5, 3.0, 4.0, and 5.0 mmol of calcium ions to trigger cluster aggregation, and kept at 37° C. for 2 h.

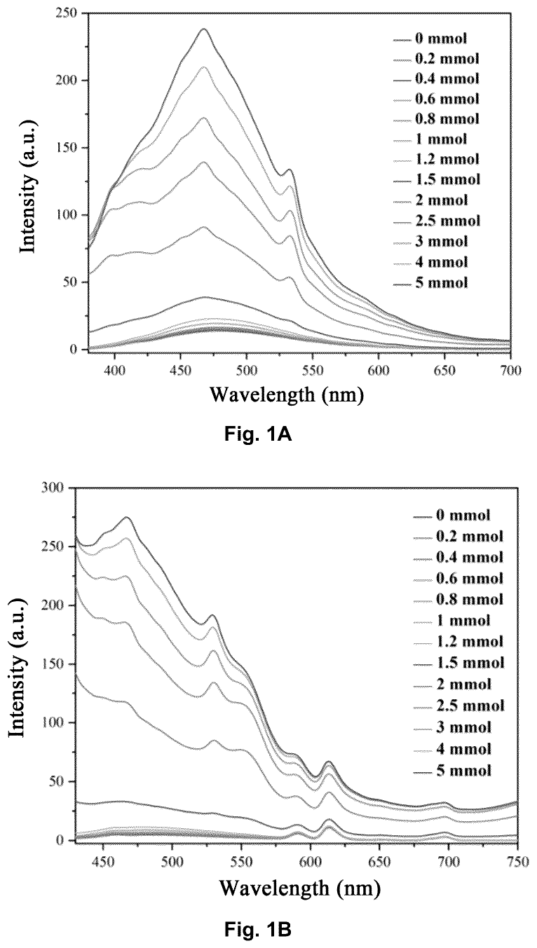

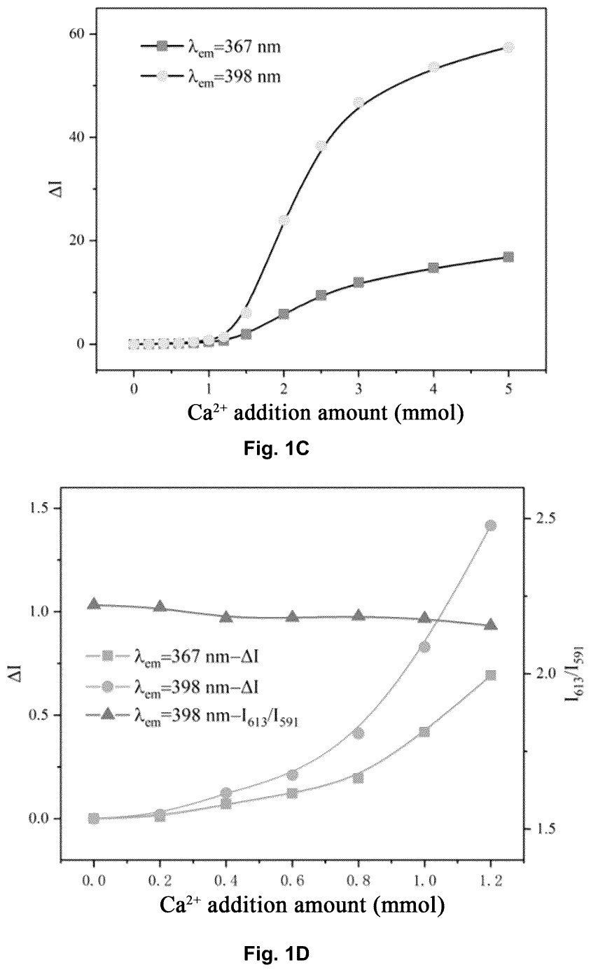

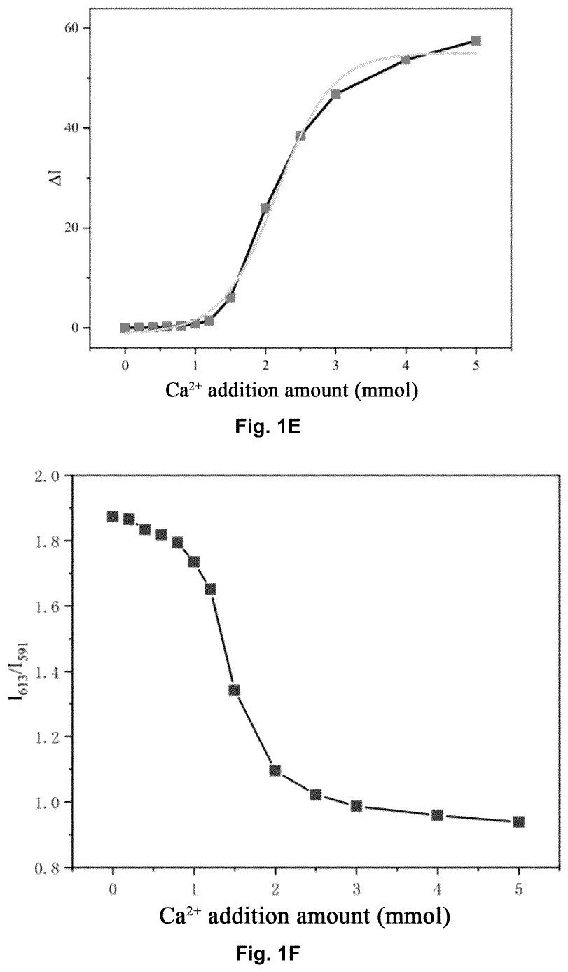

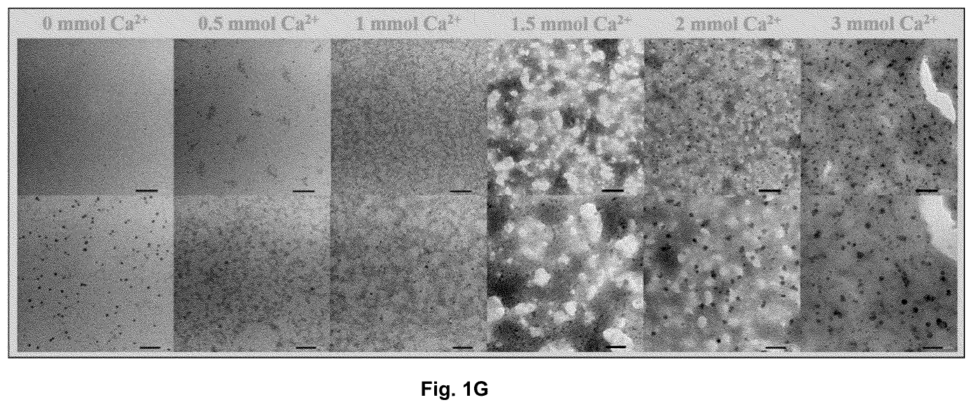

2 mL of the aggregated product was taken and placed into a quartz cuvette of a fluorescence spectrophotometer. The emission light intensities of the sample at wavelengths of 467 nm, 591 nm and 613 nm were recorded under excitation light of wavelengths of 367 nm and 398 nm, and at 25° C. and PH=7.4. FIG. 1A showed the luminescent fluorescence spectra of the product under excitation with light of a wavelength of 367 nm and at different Ca²⁺ addition amounts; and FIG. 1B showed the luminescent fluorescence spectra of the product under excitation with light of a wavelength of 398 nm and at different Ca²⁺ addition amounts. The emission fluorescence intensity growth rate ΔI of the organic molecule was calculated as: ΔI=(I−Iₚᵣₑ)/Iₚᵣₑ where/and/pre represented the fluorescence characteristic peak intensities of the PNCs solution and the PNCs aggregation crystallization product, respectively, and a relationship diagram was drawn with the added calcium ion concentration as the horizontal axis and ΔI as the vertical axis, as shown in FIG. 1C for details. It could be seen from FIG. 1D that, compared with the Eu³⁺ rare earth fluorescent probe, the TPE-COOH fluorescent probe was more sensitive to the concentration of the added calcium ion and had higher sensitivity under excitation with light of a wavelength of 398 nm. It could be seen that as a small amount of the calcium ion was added, the value of ΔI increased slightly. When the added calcium ion exceeded a critical amount, the value of ΔI increased significantly and then tended to be flat. This was similar to the colloidal properties. After fitting the curve with Boltzmann, it was found that the critical calcium ion concentration was 2.16 mmol, as shown in FIG. 1E for details.

The fluorescence emission peak ratio R_{I} of the rare earth ion was calculated, and the relationship between I₆₁₃/I₅₉₁ and the Ca²⁺ addition amount was specifically shown in FIG. 1F. As the calcium ion was added, the R_{I} value decreased slightly. When the critical amount was exceeded, the R_{I} value decreased significantly and then tended to be flat, which was consistent with the fluorescence change law of the organic molecule, indicating that the asymmetry of the coordination environment around the europium ions gradually decreased as the clusters aggregated.

FIG. 1G showed a transmission electron microscope diagram of CaP PNCs aggregates under different Ca²⁺ addition amounts, where the lower row is an enlarged image of the upper row; a scale of the upper row was 100 nm, a scale of the lower row was 50 nm, and the accuracy of the above results was verified by TEM and DLS tests.

### Example 2

Example 2 provided a method for analyzing the aggregation-crystallization process of the calcium phosphate prenucleation cluster, which was specifically as follows.

1 g/L of a TPE-COOH solution was formulated, and adjusted to a pH value of 9 to 10 by using NaOH. 5 mL of the TPE-COOH aqueous solution, 2 mmol and 25 mL of a PAA aqueous solution, 1 mmol and 5 mL of a calcium ion aqueous solution, and 0.03 mmol and 5 mL of a europium ion aqueous solution were stirred into 40 mL of a mixed solution, added with an appropriate amount of a NaOH aqueous solution to adjust the pH value of the mixed solution to 9, and stirred at 37° C. for 30 min to obtain a calcium phosphate prenucleation cluster precursor solution. The precursor solution was added with 0.6 mmol of a phosphate aqueous solution to set a final volume to 50 mL, and stirred continually at 37° C. for 2 h to obtain a calcium phosphate prenucleation cluster solution. The prenucleation cluster solution was added with 0.5 mmol, 1 mmol, 1.5 mmol, 2 mmol, and 3 mmol of calcium ions to trigger cluster aggregation, and kept in an oven at temperatures of 25° C., 37° C., and 50° C. for 2 h. 2 mL of the aggregated product was taken and placed into a quartz cuvette of a fluorescence spectrophotometer, and the emission light intensities of the sample at wavelengths of 467 nm, 591 nm and 613 nm were recorded under excitation light of a wavelength of 398 nm.

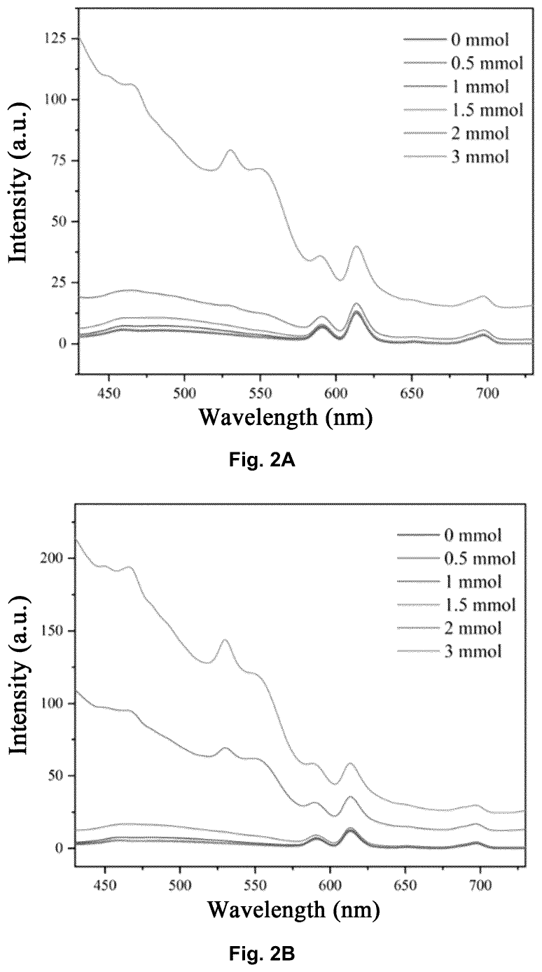

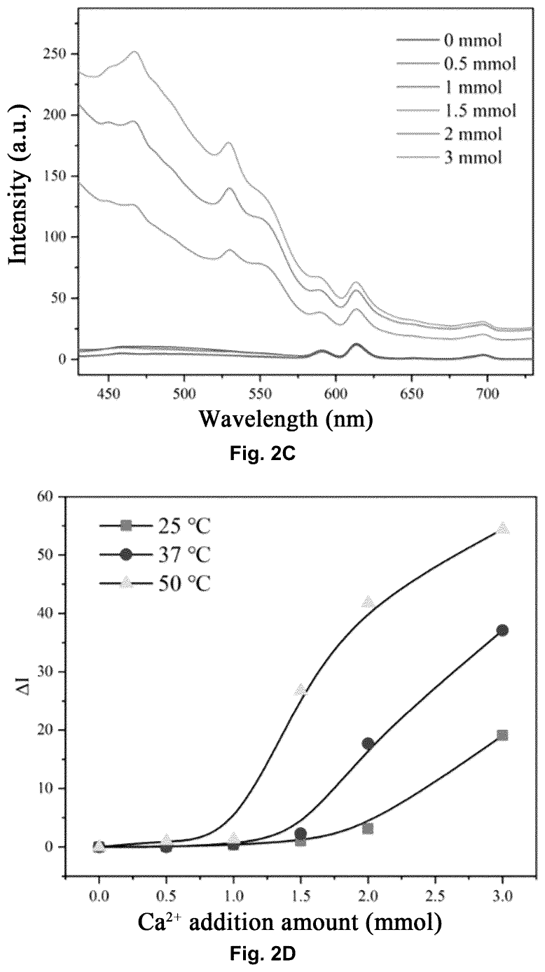

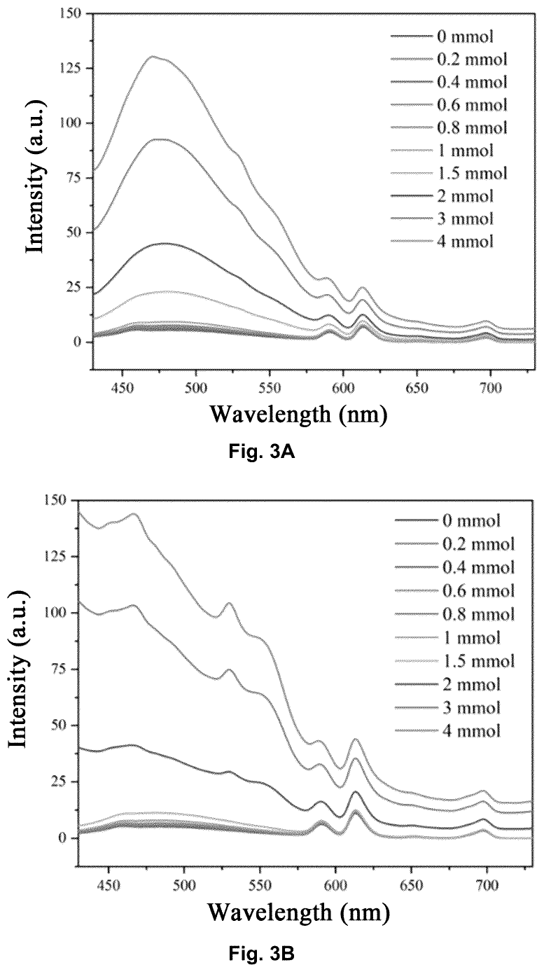

FIG. 2A, FIG. 2B, and FIG. 2C respectively showed the fluorescence emission spectra of CaP PNCs aggregation triggered by 1.5 mmol of Ca²⁺ under conditions of 25° C. (FIG. 2A), 37° C. (FIG. 2B), and 50° C. (FIG. 2C) and a pH=7.4 for 2 h. The emission fluorescence intensity growth rate ΔI of the organic molecule was calculated based on this, and a relationship diagram under different temperature conditions was drawn with the added calcium ion concentration as the horizontal axis and ΔI as the vertical axis, as shown in FIG. 2D for details. As the temperature increased, the value of ΔI gradually increased, and the overall trend of change remained unchanged. Therefore, increasing the temperature promoted aggregation and crystallization of the clusters.

### Example 3

Example 3 provided a method for analyzing the aggregation-crystallization process of the calcium phosphate prenucleation cluster, which was specifically as follows.

1 g/L of a TPE-COOH solution was formulated, and adjusted to a pH value of 9 to 10 by using NaOH. 5 mL of the TPE-COOH aqueous solution, 2 mmol and 25 mL of a PAA aqueous solution, 1 mmol and 5 mL of a calcium ion aqueous solution, and 0.03 mmol and 5 mL of a europium ion aqueous solution were stirred into 40 mL of a mixed solution, added with an appropriate amount of a NaOH aqueous solution to adjust the pH value of the mixed solution to 6, 7, 8, and 9, and stirred at 37° C. for 30 min to obtain a calcium phosphate prenucleation cluster precursor solution. The precursor solution was added with 0.6 mmol of a phosphate aqueous solution to set a final volume to 50 mL, and stirred continually at 37° C. for 2 h to obtain a calcium phosphate prenucleation cluster solution. The prenucleation cluster solution was added with 0.5 mmol, 1 mmol, 1.5 mmol, 2 mmol, and 3 mmol of calcium ions to trigger cluster aggregation, and kept at 37° C. for 2 h. 2 mL of the aggregated product was taken and placed into a quartz cuvette of a fluorescence spectrophotometer, and the emission light intensities of the sample at wavelengths of 467 nm, 591 nm and 613 nm were recorded under excitation light of a wavelength of 398 nm.

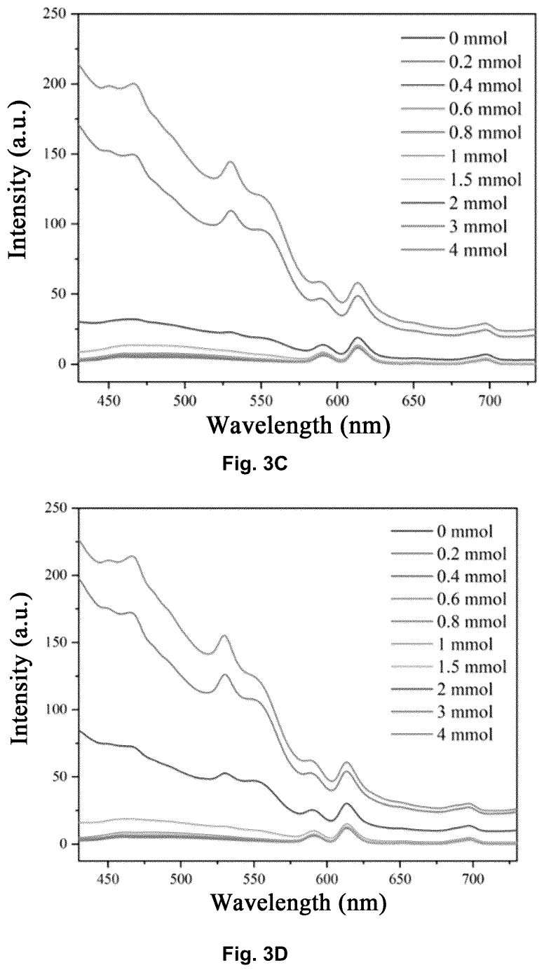

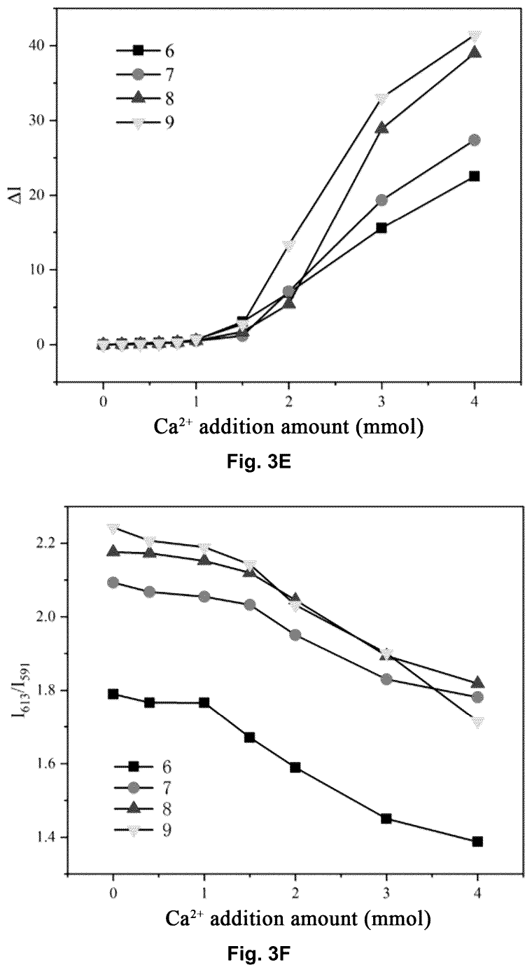

FIG. 3A, FIG. 3B, FIG. 3C, and FIG. 3D were respectively the fluorescence emission spectra of CaP PNCs aggregation triggered by action of 1.5 mmol of Ca²⁺ at 25° C. and pH=6 (FIG. 3A), 7 (FIG. 3B), 8 (FIG. 3C), and 9 (FIG. 3D) for 2 h. The emission fluorescence intensity growth rate ΔI of the organic molecule was calculated, and a relationship diagram under different pH conditions was drawn with the added calcium ion concentration as the horizontal axis and ΔI as the vertical axis. FIG. 3E showed a comparison of the changes in ΔI values under different pH values. As the pH value increased, the value of ΔI gradually increased, and the overall trend of change remained unchanged. The high pH promoted aggregation and crystallization of clusters.

The fluorescence emission peak ratio R_{I} of the rare earth ion was calculated, and FIG. 3F showed the comparison of the changes in I₆₁₃/I₅₉₁ values under different pH values. As the pH value increased, the decrease amplitude in the R_{I} value became larger, which was consistent with the fluorescence change law of the organic molecule.

### Example 4

Example 4 explored the relationship between fluorescence characteristics and crystal phases, and established a standard curve for the correlation between the two, which provided a reference standard library for the next Example 5 to determine the crystal phase by fluorescence signals. The method was specifically as follows.

5 mmol of Na₂HPO₄·12H₂O and 5 mmol of NaH₂PO₄ were dissolved in 750 ml of deionized water, and adjusted to the pH value of 3 to 6 with HCl to prepare a mixed solution A. Eu(NO₃)₃·6H₂O and Ca(CH₃COO)₂ were prepared into a mixed solution B with a Ca²⁺/Eu³⁺ concentration of 0.04 mol/L and an Eu/(Eu+Ca) molar ratio of 1% to 5%. The solution A was heated and maintained at 80° C., and then the solution B was added to solution A under stirring conditions. They were fully reacted for 10 minutes, and centrifuged to separate a precipitate. The precipitate was washed for four times, and freeze-dried to obtain Eu-OCP powder.

Eu(NO₃)₃·6H₂O and CaCl₂·2H₂O were prepared into a mixed solution with a Ca²⁺/Eu³⁺ concentration of 0.0668 mol/L and an Eu/(Eu+Ca) molar ratio of 1% to 5%. The mixed solution was heated and maintained at 37° C. 0.04 mol/L of Na₂HPO₄·12H₂O was quickly poured into the mixed solution under stirring, and meanwhile the pH value of the solution was adjusted with NaOH. The reaction was maintained for 60 minutes. Finally, the solution was centrifuged to separate a precipitate. The precipitate was washed for four times, and freeze-dried to obtain Eu-HAP powder.

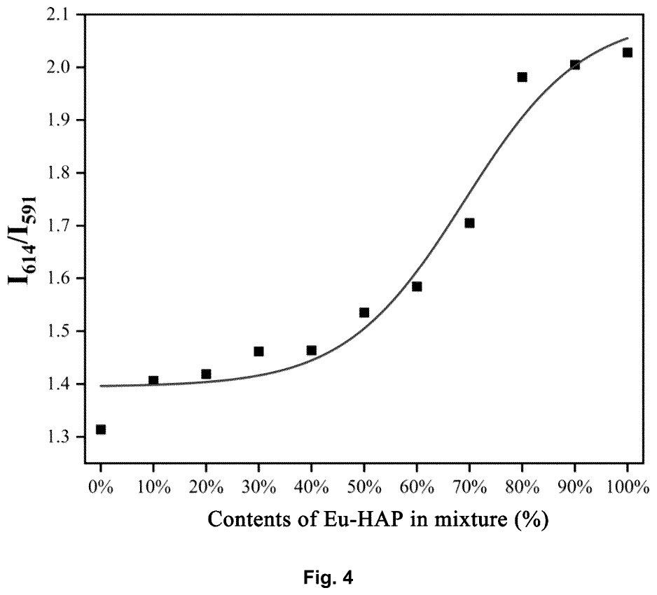

By comparing the fluorescence difference between Eu-OCP and Eu-HAP, the two showed different fluorescence characteristics in terms of fluorescence intensity and I₆₁₃/I₅₉₁ ratio. Based on the Eu³⁺ fluorescence probe, it revealed a relationship between the I₆₁₃/I₅₉₁ ratio and the mass ratio of HAP to OCP in the HAP/OCP mixture. FIG. 4 showed the relationship between the I₆₁₃/I₅₉₁ values of HAP and OCP blends with different content ratios. The Boltzmann model was fitted based on the fluorescence signal to analyze the aggregation behavior of calcium phosphate prenucleation clusters, specifically as shown in Table 1 below:

TABLE 1

| Model | Boltzmann |
|---|---|
| Equation | y = A2 + (A1 − A2)/(1 + |
| | exp((x − x0)/dx)) |
| A1 | 1.39464 ± 0.02003 |
| A2 | 2.0971 ± 0.03132 |
| x0 | 0.68956 ± 0 |
| dx | 0.11274 ± 0 |
| Reduced Chi-Sq | 0.00233 |
| COD(R\hat{ }2) | 0.96957 |

The relationship between the I₆₁₃/I₅₉₁ ratio and the HAP content (x) in the HAP/OCP mixture was (I₆₁₃/I₅₉₁=2.0971−0.70246/(1+exp ((x−0.68956)/0.11274)), R₂=0.970). Meanwhile, the relationship between the I₍₁₁₂₎/I₍₀₁₀₎ ratio and the mass ratio of HAP to OCP in the HAP/OCP mixture was revealed. The relationship between the I₍₁₁₂₎/I₍₀₁₀₎ ratio and the HAP content (x) in the HAP/OCP mixture was (I₍₁₁₂₎/I₍₀₁₀₎=4.91063E-9exp(−x/−0.04601)+0.76765exp(−x/0.76765)+0.52433exp(−x/−5.03863E89)−1.28922, R₂=0.997). With this fluorescent probe method, the crystalline phase transition from OCP to HAP in the process of OCP hydrolysis was quantitatively analyzed, which was consistent with the XRD analysis in FIG. 1A through FIG. 1G.

### Comparative Example 1

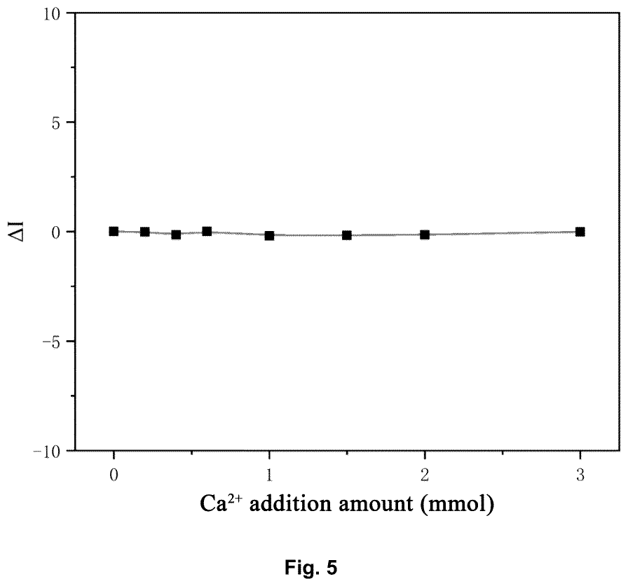

Under the same experimental conditions, different amounts of Ca²⁺ were added to the mixed solution of PAA and AIE molecules, and analyzed with a fluorescence spectrophotometer. The results were as shown in FIG. 5. There was no significant change in fluorescence intensity, indicating that the change in characteristic peak fluorescence intensity of the AIE in the example was caused by the aggregation of calcium phosphate prenucleation clusters. The AIE molecules themselves did not aggregate and crystallize.

### Example 5

Example 5 provided a method for analyzing the aggregation-crystallization process of the calcium phosphate prenucleation cluster, which was specifically as follows.

1 g/L of a TPE-COOH solution was formulated, and adjusted to a pH value of 9 to 10 by using NaOH. 5 mL of the TPE-COOH aqueous solution, 2 mmol and 25 mL of PAA, 1 mmol and 5 mL of calcium ions, and 0.03 mmol and 5 mL of europium ions were stirred into 40 ml of a mixed solution, added with an appropriate amount of a NaOH aqueous solution to adjust the pH value of the mixed solution to 7, and stirred at 37° C. for 30 min to obtain a calcium phosphate prenucleation cluster precursor solution. The precursor solution was added with 0.6 mmol of a phosphate aqueous solution to set a final volume to 50 mL, and stirred continually at 37° C. for 2 h to obtain a calcium phosphate prenucleation cluster solution. The prenucleation cluster solution was added with 1.5 mmol of calcium ions to trigger cluster aggregation, and kept at 37° C. for 2 h. The aggregated solution was added with 0 mmol, 0.3 mmol, 0.6 mmol, 0.9 mmol, 1.2 mmol, 1.5 mmol, 1.8 mmol and 2.1 mmol of phosphate solutions respectively to trigger a crystallization process. Each 2 mL of the crystallized product was taken and placed into a quartz cuvette of a fluorescence spectrophotometer, and the emission light intensities of the sample at wavelengths of 591 nm and 613 nm were recorded under excitation light of a wavelength of 398 nm.

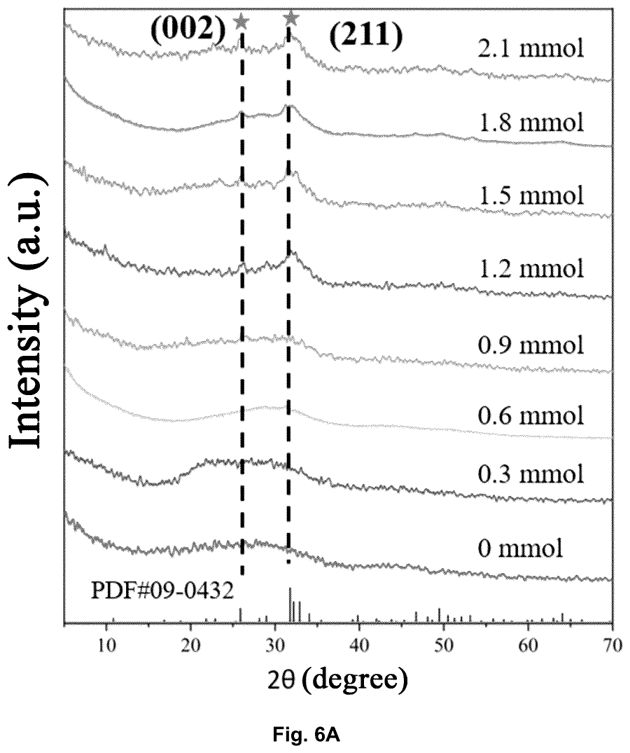

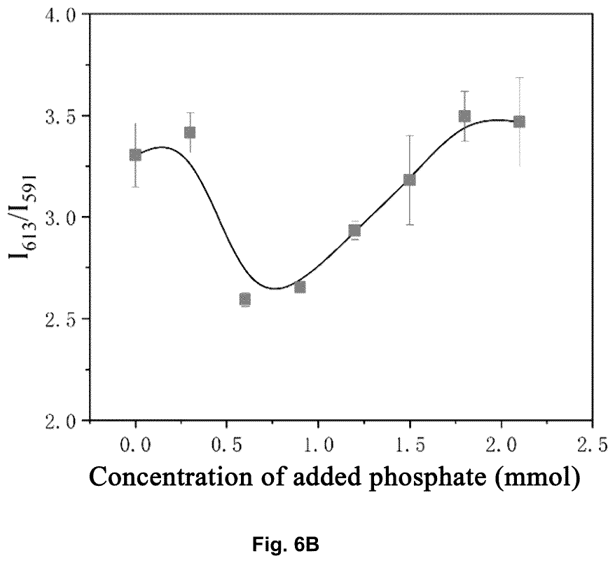

FIG. 6A showed XRD spectra of products after the crystallization of calcium phosphate aggregates was triggered by adding different concentrations of phosphates. As the concentration of the added phosphate increased, the (002) and (211) diffraction peaks representing the hydroxyapatite crystal phase became increasingly obvious, indicating that the hydroxyapatite crystal phase was gradually formed. FIG. 6B showed the ratios of the fluorescence emission peaks of the products located at 613 nm and 591 nm. It could be determined that during the crystallization process, the asymmetry of the local chemical coordination environment experienced a process of first decreasing and then increasing.

The foregoing descriptions are preferred implementations of the disclosed embodiments. It should be noted that for those skilled in the art, several improvements and modifications may further be made without departing from the principle of the present disclosure. These improvements and modifications should also be deemed as falling within the protection scope of the present disclosure.

What is claimed is:

1. A method for analyzing an aggregation-crystallization process of a calcium phosphate prenucleation cluster, comprising:
mixing a polyanion, an aggregation-induced emission organic molecule, a calcium ion and a rare earth ion in water to obtain a prenucleation cluster precursor solution;
mixing the prenucleation cluster precursor solution with a phosphate ion to obtain a prenucleation cluster solution;
inducing aggregation and crystallization of the prenucleation cluster solution sequentially to obtain an aggregated and crystallized product;
subjecting the aggregated and crystallized product to fluorescence detection; and
analyzing a formation process of the calcium phosphate prenucleation cluster by using a fluorescence signal.

2. The method of claim 1, wherein the polyanion is selected from one or more of the group consisting of polyacrylic acid, polyaspartic acid, polyglutamic acid, and polyacrylamine hydrochloride.

3. The method of claim 1, wherein the aggregation-induced emission organic molecule is selected from one or more of the group consisting of tetrakis(4-carboxyphenyl)ethylene, 9,10-di(4-carboxyphenyl) anthracene, 1,2,4,5-tetrakis(4-carboxyphenyl)benzene, and 2,3,5,6-tetrakis(4-carboxyphenyl) pyrazine.

4. The method of claim 1, wherein the rare earth ion is selected from one or more of the group consisting of a europium ion, a terbium ion, a cerium ion, a dysprosium ion, a thulium ion, and a samarium ion.

5. The method of claim 1, wherein a molar ratio of the calcium ion to the rare earth ion is within an approximate range of 1:0.005 to 1:0.05.

6. The method of claim 1, wherein a molar ratio of the calcium ion to the polyanion is within an approximate range of 1:1 to 1:3.

7. The method of claim 1, wherein a molar ratio of the calcium ion to the aggregation-induced emission organic molecule is within an approximate range of 1:0.005 to 1:0.05.

8. The method of claim 1, wherein a molar ratio of the calcium ion to the phosphate ion is within an approximate range of 1:0.1 to 1:1.

9. The method of claim 1, wherein
a pH value of the prenucleation cluster precursor solution is within an approximate range of 6 to 12; and
a pH value of the prenucleation cluster solution is within an approximate range of 6 to 12.

10. The method of claim 9, comprising a step of using NaOH to adjust the pH value.

11. The method of claim 1, further wherein the step of mixing a polyanion, an aggregation-induced emission organic molecule, a calcium ion and a rare earth ion comprises mixing a polyanion aqueous solution, an aggregation-induced emission organic molecule aqueous solution, a calcium ion aqueous solution and a rare earth ion aqueous solution, and stirring at a temperature within an approximate range of 25° C. to 80° C. for a duration within an approximate range of 2 hours to 12 hours to obtain a prenucleation cluster precursor solution.

12. The method of claim 1, wherein the step of inducing aggregation of the prenucleation cluster solution comprises adding a calcium ion into the prenucleation cluster solution to obtain a mixed solution, or evaporating water in the mixed solution.

13. The method of claim 12, wherein the step of inducing aggregation of the prenucleation cluster solution comprises evaporating water by stirring the mixed solution at a temperature within an approximate range of 25° C. to 50° C. for a duration within an approximate range of 1 hour to 3 hours.

14. The method of claim 12, wherein the step of inducing aggregation of the prenucleation cluster solution comprises evaporating water by stirring the mixed solution at a temperature within an approximate range of 35° C. to 40° C. for a duration within an approximate range of 1.5 hours to 2.5 hours.

15. The method of claim 1, wherein the step of inducing crystallization comprises adding a phosphate into the mixed solution after aggregation.

16. The method of claim 1, wherein the method comprises fitting a Boltzmann model according to the fluorescence signal to analyze an aggregation behavior of the calcium phosphate prenucleation cluster.

17. The method of claim 16, wherein the method further comprises determining a size of a calcium phosphate agglomerate according to an amplification rate of a fluorescence signal of the organic molecule and a characteristic peak ratio of the rare earth ion.

18. The method of claim 16, wherein the method further comprises determining a calcium phosphate crystal form and monitoring crystal phase transformation of octacalcium phosphate to hydroxyapatite according to a characteristic peak ratio of the rare earth ion.

19. The method of claim 1, wherein the fluorescence signal includes fluorescence emission characteristic peaks of the organic molecule and the rare earth ion.

20. The method of claim 1, wherein the method further includes determining a calcium phosphate crystal form according to a characteristic peak ratio of the rare earth ion.
